(19) United States
(12) Patent Application Publication
(10) Pub. No.: US 2002/0152178 A1
(43) Pub. Date: Oct. 17, 2002

(54) Credit card transaction authentication system and method using mobile terminal

(75) Inventor: Sang-Woo Lee, Seoul (KR)

Correspondence Address: Jonathan Y. Kang, Esq., Lee & Hong P.C., 11th Floor, 221 N. Figueroa Street, Los Angeles, CA, 90012-2601, US

(73) Assignee: M-Commerce Co., Ltd.

(21) Appl. No.: 09/871,330

(22) Filed: May 30, 2001

(30) Foreign Application Priority Data
Apr. 12, 2001 (KR) 2001-19517

(51) Int. Cl. G06F 17/60

(52) U.S. Cl. 705/67

(57) ABSTRACT

The present invention relates to a credit card transaction authentication system and method using a mobile terminal. There is provided a credit card transaction authentication system using a mobile terminal for performing a work of credit card authentication for a relay system of a VAN company connected between an approval system of a credit card company, which can approve a credit card settlement of the prices, and a transaction approval terminal, which requests credit card transaction approval by means of contactless radio-frequency identification for the mobile terminal containing a transponder therein. The present invention provides advantages that a cumbersome procedure in which the credit card should be handed over and taken again by the user upon making the credit card settlement can be eliminated, and stability of credit card information can be enhanced so that a commercial transaction can be briskly made.

### FIELD OF INVENTION

The present invention relates to a credit card transaction authentication system and method using a mobile terminal, and more particularly, to a credit card transaction authentication system and method using a mobile terminal, which are adapted for performing a credit card settlement by means of contactless radio-frequency identification of a cellular phone.

### BACKGROUND OF INVENTION

Recently, as a result of the shift to a credit society, there is a growingly tendency toward payment of the prices for goods or services by a credit card.

First, a procedure for performing the payment of the prices by such a credit card will be described below.

FIG. 1 is a relational view of a credit card transaction approval method according to a prior art.

As shown in the figure, when a credit card owner (user) 11 presents his/her credit card and offers a purchase request to a member store 12 in order to pay the prices for goods or services (ST100), the member store 12 prepares a telegram of a transaction approval request by combining user's information recorded in the credit card of the user 11 and a breakdown of the transaction and member store's information generated by a credit card transaction approval terminal installed in the member store, and then requests the approval from a credit card company 16 through a wire or wireless telephone network.

That is, the telegram of the transaction approval request (for example, the combination of user's information, breakdown of transaction, member store' information) issued from the member store 12 is transmitted through the telephone network 13 to a relay system of a value added network (VAN) company 14 (ST110). Here, the VAN company 14 is a relay company which receives the telegram of the transaction approval request from the member store 12, transmits it to the credit card company 16, receives a result of the transaction approval request from the credit card company 16 again, and then transmits the member store 12 of the result. At this time, since the credit card transaction approval terminal has an apparatus or program set therein for transmitting information only to a relay system of a specific VAN company 14, an approval request issued from a specific credit card transaction approval terminal can be transmitted only to a relay system of a specific VAN company 14 corresponding thereto.

The relay system of the VAN company 14, which has received the telegram of the transaction approval request, reads credit card company's information in the user's information included in the telegram of the transaction approval request, and transmits a combination of data related to the approval request to a settlement approval system of the pertinent credit card company 16 (ST120). The relay system of the VAN company 14 is connected through a dedicate packet network 15 with the approval system of the pertinent credit card company 16.

The approval system of the credit card company 16, which has received the transaction approval request, compares the user's information, the breakdown of the transaction, and the member store's information included in a breakdown of the transaction approval request with member's data or member store' data which the credit card company owns, respectively. It is verified as to whether both the user 11 and the member company 12 are not disqualified from transaction signatories and the transaction made between them is valid.

Then, the credit card company 16 returns a result of the transaction approval request, through the packet network 15, etc., to the VAN company 14 which has relayed the transaction approval request (ST130).

The relay system of the VAN company 14 to which the transaction approval result is returned reads the member store's information included in the breakdown of the transaction approval result and returns the transaction approval result, through the telephone network 13, to the transaction approval terminal of the member store 12 from which the transaction approval request is originally issued (ST140).

The transaction approval terminal of the member store 12, which has received the transaction approval result from the relay system of the VAN company 14, informs the user of the payment result based on a breakdown of the transaction approval result and allows the user to sign.

However, in such conventional credit card transaction approval method, there is a problem in that the settlement by the credit card is cumbersome since the credit card user takes out his/her credit card and hands over it to a seller, and the seller, who has received the credit card, causes the transaction approval terminal to recognize the credit card and then returns the credit card to the user again.

Further, there is also another problem in that since the credit card should be moved in a state that it is in contact with a recognizing portion (magnetic strip) attached to the transaction approval terminal in order to cause the transaction approval terminal to recognize the credit card, the credit card is damaged due to friction.

In addition, there is a further problem in that since various credit card companies issue credit cards different from each other and a user, who has obtained credit cards from the various credit card companies and intends to selectively use them if necessary, should carry a plump purse containing a plurality of credit cards or mileage cards with him/her, it is inconvenient to use the credit cards.

On the other hand, there is a still further problem in that since the telegram of the transaction approval request, which is generated from the member store and transmitted to the relay system of the VAN company through the wire or wireless telephone network or the like, includes user's information such as a credit card number recorded in a credit card, information on the credit card of the user may be exposed to outside.

### SUMMARY OF INVENTION

Therefore, the present invention is conceived to solve the problems of the prior art as mentioned above. It is an object of the present invention to provide a credit card transaction authentication system and method using a mobile terminal, wherein a credit card settlement can be made simply by bringing a mobile terminal to a transaction approval terminal of a member store, thereby eliminating a cumbersome procedure in which a credit card should be handed over and taken again by a user upon making the credit card settlement.

It is another object of the present invention to provide a credit card transaction authentication system and method using a mobile terminal, wherein a credit card settlement can be made by means of contactless radio-frequency identification performed between a mobile terminal and a transaction approval terminal, thereby preliminarily preventing damage to a credit card, and the like.

It is a further object of the present invention to provide a credit card transaction authentication system and method using a mobile terminal, wherein a user can select and set one to be used among a plurality of credit cards possessed by the user and can change the setting if the user intends to use another credit card, thereby releasing the user from inconvenience of carrying a plump purse in which a plurality of credit cards are contained and preventing exposure of information in case of carrying the credit cards with him/her.

According to the present invention for achieving the above objects, there is provided a credit card transaction authentication system using a mobile terminal for performing a work of credit card authentication for a relay system of a VAN company connected between an approval system of a credit card company, which can approve a credit card settlement of the prices, and a transaction approval terminal, which requests credit card transaction approval by means of contactless radio-frequency identification of the mobile terminal containing a transponder therein. The credit card transaction authentication system comprises a process server connected with the relay system of the VAN company through a network, for operating a site, which provides an environment capable of performing registration and modification of credit card information for a credit card settlement function by means of the contactless radio-frequency identification of the mobile terminal, and for controlling said credit card transaction authentication system to perform the work of credit card authentication for the relay system of the VAN company; an authentication engine which in accordance with control of the process server, upon receipt of credit card authentication request data on the mobile terminal from the relay system of the VAN company that has received price settlement request data generated from the transaction approval terminal by means of the contactless radio-frequency identification of the mobile terminal, extracts credit card connection information on the mobile terminal, based on the received authentication request data and transmits authentication data to the relay system of the VAN company; and a database server for storing information on a user of the mobile terminal, the credit card connection information resulted from the contactless radio-frequency identification of the mobile terminal, and information on a peculiar code of the transponder contained in the mobile terminal, according to the control of the process server.

In addition, according to the present invention, there is provided a credit card transaction authentication system using a mobile terminal, comprising a process server connected, through a network, with an approval system of a credit card company, which can approve a credit card settlement of the prices, and with a transaction approval terminal, which requests credit card transaction approval by means of contactless radio-frequency identification of a mobile terminal containing a transponder therein, for performing control to provide a work of credit card authentication in response to the credit card settlement of the prices by the contactless radio-frequency identification carried out between the mobile terminal and the transaction approval terminal; an authentication engine which in accordance with the control of the process server, upon receipt of price settlement request data generated from the transaction approval terminal by means of the contactless radio-frequency identification of the mobile terminal, extracts credit card connection information set in the mobile terminal, based on the received price settlement request data, transmits transaction approval request data to an approval system of a credit card company corresponding to the extracted credit card connection information, and, upon return of a transaction approval data for the transaction approval request data, transmits transaction approval result data to the transaction approval terminal; and a database server for storing information on a user of the mobile terminal, member store's information for the transaction approval terminal, the credit card connection information resulted from the contactless radio-frequency identification of the mobile terminal, information on a peculiar code of the transponder contained in the mobile terminal, and the like, according to the control of the process server.

Further, according to the present invention, there is provided a credit card transaction authentication method using a mobile terminal, performed by a credit card transaction authentication system toward a relay system of a VAN company connected between a transaction approval terminal, which requests a credit card settlement for the prices by means of contactless radio-frequency identification of the mobile terminal containing a transponder therein, and a credit card company, which can approve the credit card settlement of the prices. The credit card transaction authentication method comprises a registration step of receiving and registering credit card connection information including a credit card number and the term of validity of a credit card in correspondence with a peculiar code of the transponder contained in the mobile terminal; a receipt step of receiving credit card authentication request data including the peculiar code of the transponder contained in the mobile terminal from the relay system of the VAN company which has received data on the credit card settlement for the prices generated by means of the contactless radio-frequency identification performed between the mobile terminal and the transaction approval terminal; an extraction step of recognizing the peculiar code of the transponder in the received authentication request data, and extracting the credit card connection information such as the credit card number and the term of validity corresponding to the recognized peculiar code of the transponder; and a transmission step of, upon extraction of the credit card connection information, generating authentication data such as the credit card number and the term of validity corresponding to the credit card connection information, and transmitting the generated authentication data to the relay system of the VAN company.

Furthermore, according to the present invention, there is provided a credit card transaction authentication method using a mobile terminal, performed by a credit card transaction authentication system between a transaction approval terminal, which requests a credit card settlement for the prices by means of contactless radio-frequency identification of the mobile terminal containing a transponder therein, and an approval system of a credit card company, which can approve the credit card settlement of the prices, to make the credit card settlement of the prices by means of the contactless radio-frequency identification between the mobile terminal and the transaction approval terminal. The credit card transaction authentication method comprises a registration step of receiving and registering credit card connection information including a credit card number and the term of validity of a credit card in correspondence with a peculiar code of the transponder contained in the mobile terminal; a receipt step of receiving price settlement request data including the peculiar code of the transponder contained in the mobile terminal generated from the transaction approval terminal by means of the contactless radio-frequency identification of the mobile terminal; an extraction step of recognizing the peculiar code of the transponder in the received price settlement request data, and extracting the credit card connection information such as the credit card number and the term of validity corresponding to the recognized peculiar code of the transponder; a transaction approval request step of, upon extraction of the credit card connection information, generating transaction approval request data including the credit card number, and transmitting the generated transaction approval request data to the approval system of the credit card company corresponding to the credit card connection information; and a credit card authentication/approval step of, upon return of approval data for the transaction approval request data from the approval system of the credit card company, transmitting transaction approval result data to the transaction approval terminal.

### BRIEF DESCRIPTION OF THE DRAWINGS

FIG. 1 is a relational view of a credit card transaction approval method according to a prior art.

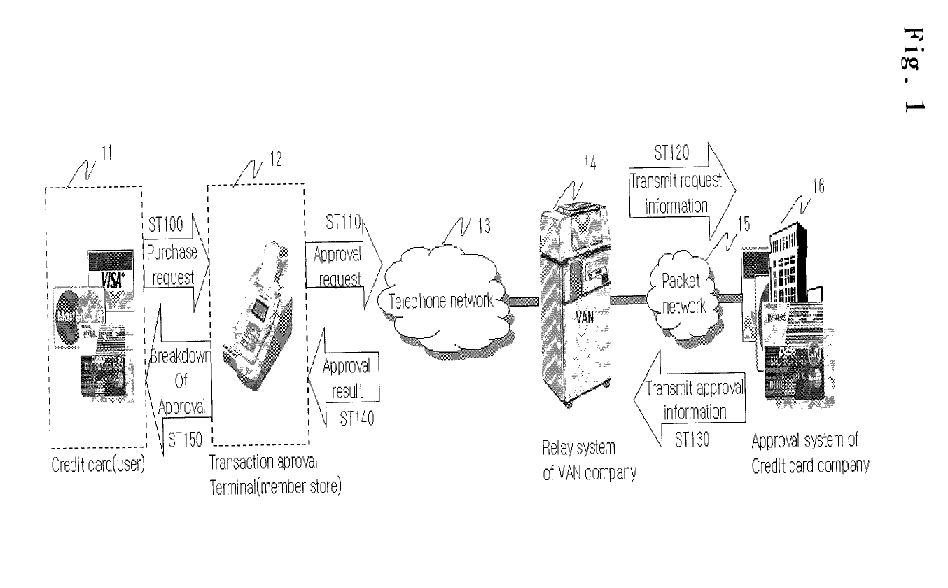

FIG.2 is a relational view schematically showing a credit card authentication and transaction approval method for a credit card settlement using contactless radio-frequency identification of a mobile terminal, to which the present invention is applied.

FIG. 3 is a constitutional view of a credit card transaction authentication system using a mobile terminal, to which the present invention is applied.

FIG. 4 is a flowchart showing a credit card transaction authentication method using a mobile terminal, according to an embodiment of the present invention.

FIG. 5 is a flowchart fully showing a registration step that may be further employed in the embodiment shown in FIG. 4.

FIG. 6 is a flowchart fully showing an extraction step that may be further employed in the embodiment shown in FIG. 4.

FIG. 7 is a relational view schematically showing a credit card transaction authentication and transaction approval method further including a point of sale (POS) server that may be further employed in the embodiment shown in FIG. 2.

FIG. 8 is a conceptual view schematically showing credit card authentication of a credit card transaction authentication system using a mobile terminal, according to an embodiment of the present invention.

### DETAILED DESCRIPTION FOR PREFERRED EMBODIMENT

Hereinafter, a credit card transaction authentication system and method using a mobile terminal of the present invention will be explained in detail with reference to the accompanying drawings.

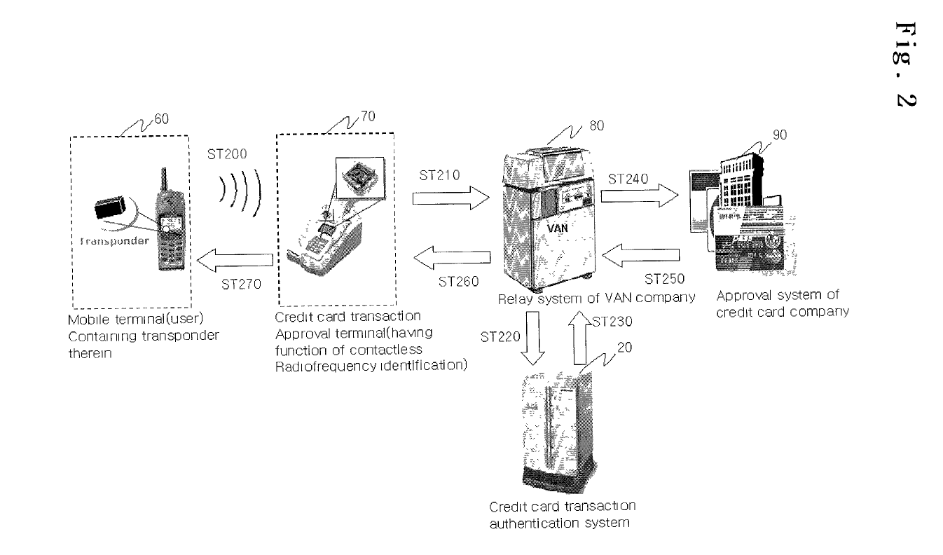

FIG. 2 is a relational view schematically showing a credit card authentication and transaction approval method for a credit card settlement using contactless radio-frequency identification of a mobile terminal, to which the present invention is applied.

As shown in the figure, when a possessor (user) of a mobile terminal 60 containing a transponder therein offers a purchase request while bringing the mobile terminal to a transaction approval terminal 70 of a member store in order to pay the prices for goods or services, the transaction approval terminal 70 combines credit card authentication request data, such as a peculiar code of the transponder, with settlement data, such as a breakdown of the transaction, generated from the transaction approval terminal 70 by using the contactless radio-frequency identification and prepares price settlement request data. Then, the transaction approval terminal 70 requests an approval system of a credit card company 90 to approve the transaction through a network such as a wire or wireless telephone network.

Herein, the transponder contained in the mobile terminal 60 is a chip that performs a function of radio-frequency identification. The transponder may be separately attached to the mobile terminal 60 and make communication using radio frequency without assistance of a battery. The transponder is constructed to automatically transmit its peculiar code and/or encryption key to a card reader 50 when it falls within a sensing region of an antenna attached to the transaction approval terminal 70.

The use of the encryption key serves to further reinforce the procedure of the credit card transaction authentication using the mobile terminal so as to completely prevent the transponder from being counterfeited and used.

Therefore, the present invention may use only the peculiar code of the transponder or the encryption key therewith, as the credit card authentication request data. However, this embodiment will be described in case where the credit card authentication request data including the encryption key are used.

In addition, the mobile terminal 60 may be a terminal, such as a cellular phone, a personal digital assistant (PDA), an IMT 2000 terminal, that contains the transponder therein and is based on a network.

As described above, the present invention uses the mobile terminal as a medium for containing the transponder by which a credit card is substituted. This is because general users always carry the mobile terminal with them. Since the transponder can perform the identical function even when it is contained in a key ring, a traffic card, a purse, etc., which the general users always carry with them, except for the mobile terminal, the mobile terminal used in the present invention can be substituted by the key ring, the traffic card, the purse, or the like.

On the other hand, the transaction approval terminal 70 of the member store includes an antenna, a contactless radio-frequency identification module, and a CPU in order to perform the contactless radio-frequency identification of the mobile terminal 60 containing the transponder therein. The transaction approval terminal 70 sends a transmitting frequency signal through the antenna to charge the transponder located within the sensing region, and receives, through the antenna, data sent by the transponder.

Furthermore, the transaction approval terminal 70 generates a rolling code, combines it with the encryption key of the transponder to generate a response code, and transmits the credit card authentication request data (rolling code, peculiar code, encryption key, and response code) (ST200).

That is, price settlement request data (a combination of the peculiar code, the encryption key, the rolling code, the response code, the breakdown of the transaction, and member store's information) generated from the transaction approval terminal 70 of the member store are transmitted to a relay system of a value added network (VAN) company 80 through a wire or wireless telephone network, or the like (ST210).

The relay system of the VAN company 80 which has received the price settlement request data transmits credit card authentication request data (the peculiar code, the encryption key, the rolling code, and the response code) included in the price settlement request data to a transaction authentication system 20 (hereinafter, simply referred to as “authentication system”) (ST220).

The authentication system 20 recognizes the peculiar code of the transponder in the received authentication request data, extracts credit card connection information, such as a credit card number and the term of validity, corresponding to the recognized peculiar code of the transponder, and then transmits the extracted information to the relay system of the VAN company 80 (ST230).

The relay system of the VAN company 80, which has received the card connection information such as the credit card number, transmits a combination of data related to an approval request to the approval system of the pertinent credit card company 90 (ST240).

The approval system of the credit card company 90, which has received the transaction approval request, verifies whether there are reasons for disqualification in the transaction, and returns a result of the transaction approval request to the relay system of the VAN company 80 (ST250).

The relay system of the VAN company 80 to which the transaction approval result is returned reads the member store's information included in the breakdown of the transaction approval result and returns the transaction approval result, through the telephone network or the like, to the transaction approval terminal 70 of the member store from which the price settlement request data is originally issued (ST260).

The transaction approval terminal 70 of the member store, which has received the transaction approval result from the relay system of the VAN company 80, informs the user 60 of a result of the price settlement request based on the breakdown of the transaction approval result (ST270).

The authentication system 20 of the present invention performs a work of credit card authentication for the relay system of the VAN company 80 connected between the approval system of the credit card company 90, which can approve the credit card settlement of the prices, and the transaction approval terminal 70, which requests the credit card transaction approval by means of the contactless radio-frequency identification of the mobile terminal 60 containing the transponder therein.

In such way, the credit card transaction authentication system and method using the mobile terminal according to the present invention enables the credit card settlement to be made simply by bringing the mobile terminal to the transaction approval terminal, thereby eliminating a cumbersome procedure in which the credit card should be handed over and taken again by the user upon making the credit card settlement.

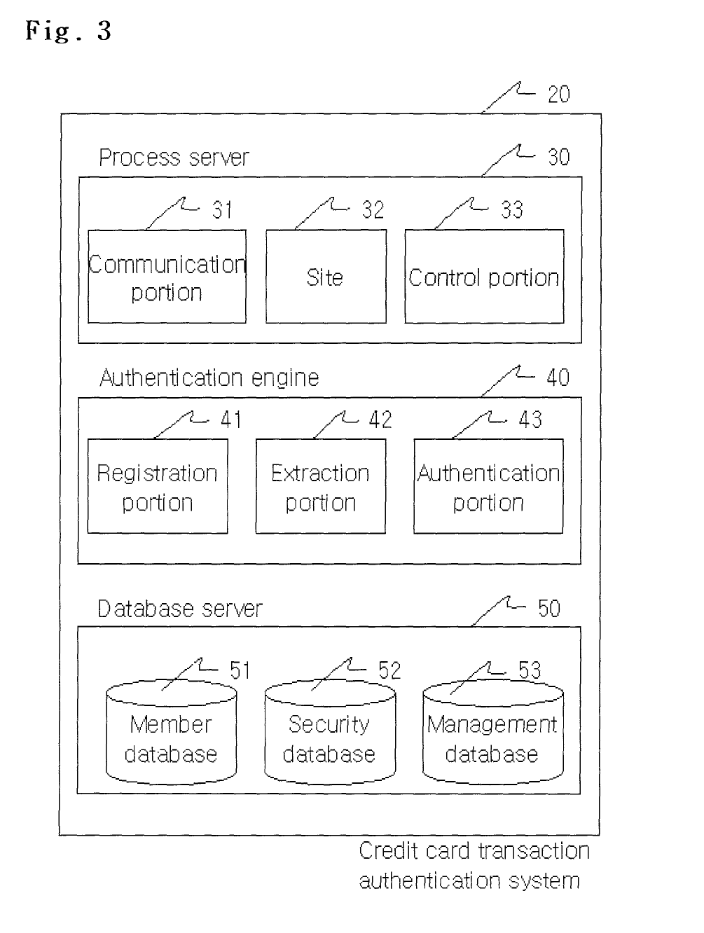

FIG. 3 is a constitutional view of the credit card transaction authentication system using the mobile terminal, to which the present invention is applied.

As shown in the figure, the authentication system 20 includes a process server 30, an authentication engine 40, and a database server 50.

The process server 30 includes a communication portion 31, a site 32, and a control portion 33.

Here, the communication portion 31 provides communication environment (web, mobile, private line communication, etc.) by means of network means (network adapter, protocol, etc.), and hardware (network devices, etc.), which enable the process server to communicate with the relay system or the like through the network.

In addition, the site 32 is a web page or a mobile page for providing a worldwide web service or mobile service. The site 32 provides the user with an environment, such as member registration of the user of the mobile terminal, and registration, change and environment configuration of the credit card information for the mobile terminal.

Further, the control portion 33 includes a hardware driver for controlling the operation of the authentication system 20, and applications required for the authentication system 20. The control portion 33 controls a series of operations for the relay system of the VAN company to perform the work of credit card authentication so that the credit card settlement can be made by means of the contactless radio-frequency identification of the mobile terminal.

The authentication engine 40 includes a registration portion 41, an extraction portion 42, and an authentication portion 43.

The registration portion 41 receives the user's information such as personal data on the user of the mobile terminal, through the network, and accordingly receives the peculiar code and the encryption key of the transponder contained in the mobile terminal, and the credit card connection information such as the credit card number and the term of validity of the credit card owned by the user of the mobile terminal. Then, it registers them at the database server 50.

Furthermore, the extraction portion 42 receives the credit card authentication request data on the mobile terminal from the relay system of the VAN company which has received the price settlement request data generated from the transaction approval terminal by means of the contactless radio-frequency identification of the mobile terminal.

Then, the extraction portion 42 extracts the credit card connection information, such as the credit card number and the term of validity of the credit card set in the mobile terminal, based on the received authentication request data.

On the other hand, the authentication portion 43 transmits authentication data including the credit card number to the relay system of the VAN company based on the credit card connection information extracted by the extraction portion 42, so that the credit card transaction authentication for the mobile terminal can be achieved.

The database server 50 includes a member database 51, a security database 52, and a management database 53.

The member database 51 stores the member's information, such as an ID, a password, and basic personal data received when the user of the mobile terminal requests a subscription to a member, and the credit card connection information, such as the credit card number and the term of validity of the credit card owned by the user of the mobile terminal.

The security database 52 stores the information on the peculiar code and the encryption key of the transponder contained in the mobile terminal, etc., in correspondence with the credit card connection information.

Further, the management database 53 stores history information on the transmission of the authentication data from the relay system of the VAN company based on the credit card authentication request data, user's environment configuration information for the credit card authentication request from the mobile terminal, and the like.

The environment configuration information means the contents set by the user of the mobile terminal in connection with a locking function for the authentication request, an informing function, a function of integrating a breakdown of a settlement, etc.

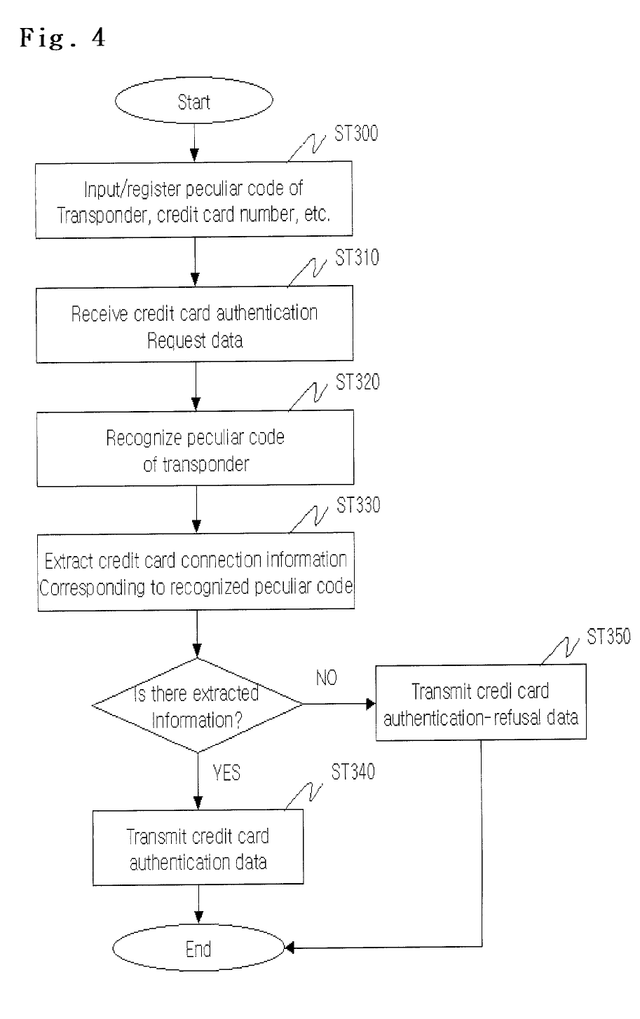

FIG. 4 is a flowchart showing a credit card transaction authentication method using the mobile terminal, according to an embodiment of the present invention.

This procedure is a program which is processed by he process server 30, the authentication engine 40, and the database server 50 in response to the operation of the relay system of the VAN company 80 connected between the credit card company 90, which can approve the credit card settlement of the prices, and the transaction approval terminal 70, which requests the credit card settlement of the prices by means of the contactless radio-frequency identification of the mobile terminal 60 containing the transponder therein. The authentication system 20 is provided with this program.

Referring to the figure, the authentication system 20 of the present invention receives the encryption key of the transponder and the credit card connection information, such as the credit card number and the term of validity of the credit card, from the user of the mobile terminal, in correspondence with the peculiar code of the transponder contained in the mobile terminal, and stores them at the database server (ST300).

After registration step ST300, the credit card authentication request data for the peculiar code of the transponder contained in the mobile terminal are received from the relay system of the VAN company which has received the price settlement request data generated from the transaction approval terminal by means of the contactless radio-frequency identification of the mobile terminal 60 (ST310).

After receiving step ST310, the peculiar code of the transponder in the received authentication request data is recognized (ST320), and the credit card connection information, such as the credit card number and the term of validity, corresponding to the recognized peculiar code of the transponder is extracted (ST330).

When the credit card connection information is extracted after extraction step ST330, the authentication data, such as the credit card number and the term of validity, corresponding to the credit card connection information are generated and then transmitted to the relay system of the VAN company (ST340).

When it is impossible to extract the credit card connection information at extraction step ST330 due to problems such as absence of the credit card connection information corresponding to the peculiar code of the transponder, setting of locking the credit card authentication, termination of the term of validity of the credit card, etc., the procedure proceeds to step ST350 so as to transmit authentication-refusal data for the authentication request data to the relay system of the VAN company.

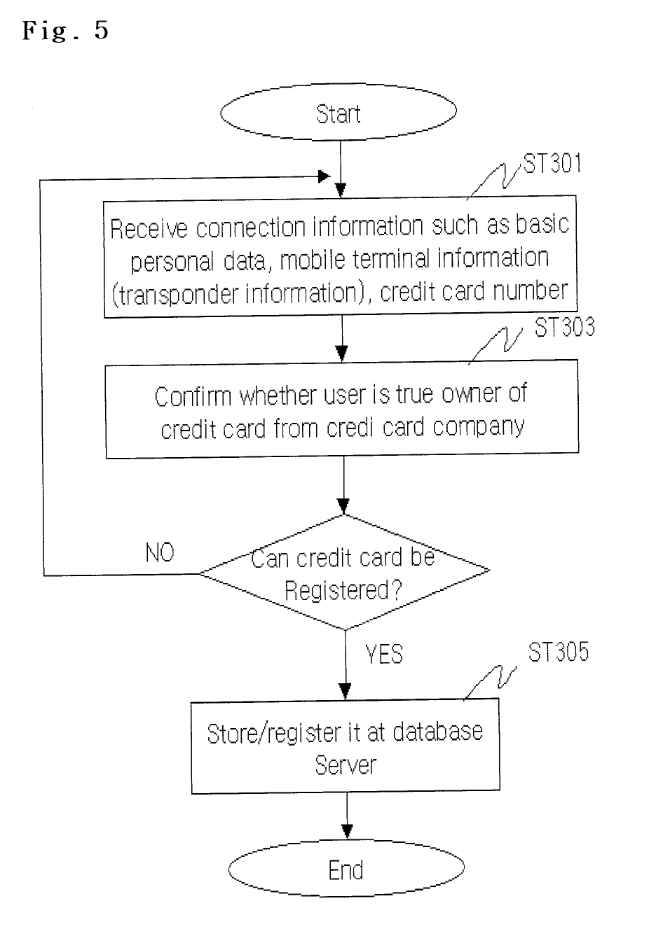

FIG. 5 is a flowchart fully showing a registration step that may be further employed in the embodiment shown in FIG. 4.

Referring to the figure, when the user of the mobile terminal subscribes to a member, the basic personal data, information (peculiar code, encryption key, etc.) on the mobile terminal containing the transponder, the credit card connection information such as the credit card number and the term of validity of the user's credit card, and the like are inputted and received (ST301).

Then, the approval system of the credit card company confirms as to whether the user is a true owner of the credit card and the credit card is available, based on the personal data such as a resident registration number, and the credit card connection information such as the credit card number (ST303).

When it is determined by the approval system of the credit card company that the user is a true owner of the credit card and the credit card is available, the credit card connection information such as the credit card number and the term of validity of the credit card, and the encryption key of the transponder are registered at the database server 50, in correspondence with the peculiar code of the transponder (ST305).

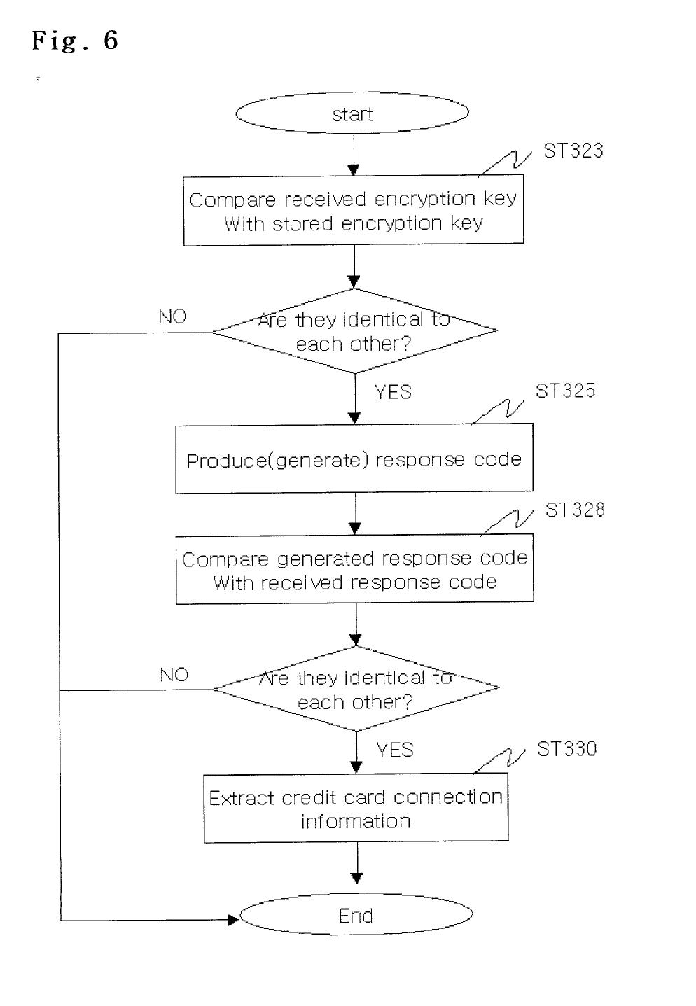

FIG. 6 is a flowchart fully showing an extraction step that may be further employed in the embodiment shown in FIG. 4.

Referring to the figure, the encryption key stored in the database server 50 is extracted by using the peculiar code of the transponder included in the credit card authentication request data received from the relay system of the VAN company, and then is compared with the encryption key included in the received credit card authentication request data (ST323).

Then, when the received encryption key conforms to the stored encryption key, a response code is calculated and generated by combining the stored encryption key and the rolling code in the received credit card authentication request data (ST325).

The calculated response code is compared with the response code in the received credit card authentication request data (ST328). When the two response codes are identical to each other, the credit card connection information, such as the credit card number and the term of validity, corresponding to the received peculiar code of the transponder is extracted (ST330).

When it is determined as being different from each other at steps ST323 and ST328, the credit card connection information is not extracted and the procedure is terminated.

In such way, since a telegram of the price settlement request data transmitted from the transaction approval terminal of the member store does not include the user's information, such as the credit card number, recorded in the credit card, there are advantages in that the credit card information of the user of the credit card is not exposed and the credit card settlement can be made safely.

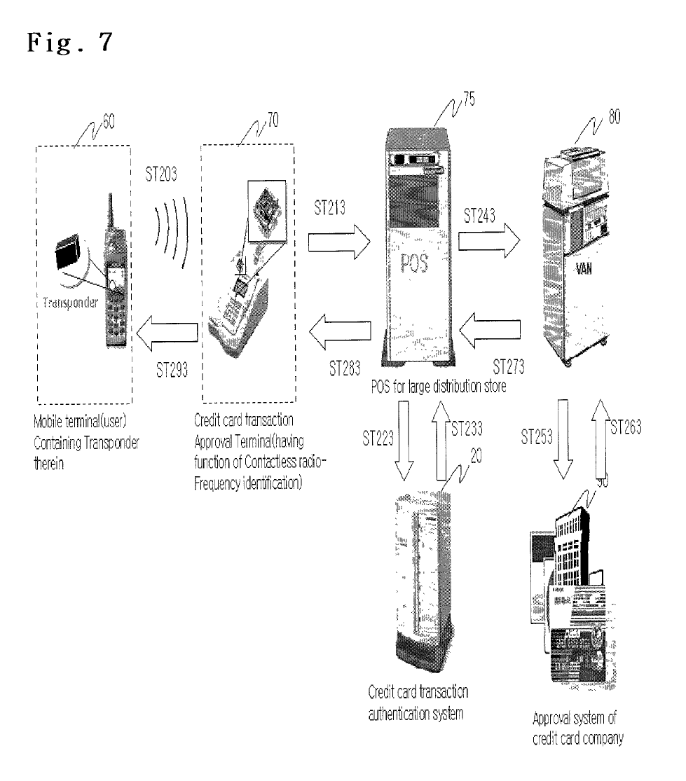

FIG. 7 is a relational view schematically showing a credit card transaction authentication and transaction approval method further including a point of sale (POS) server that may be further employed in the embodiment shown in FIG. 2.

As shown in the figure, the POS server 75 is further provided between the transaction approval terminal 70 and the relay system of the VAN company 80. The credit card transaction authentication system 20 performs a work of credit card authentication for the POS server 75.

Here, the POS server 75 is a system in which total stock is adjusted just upon reading a bar code attached to goods and a series of required processes (credit inquiry, credit card authentication request, etc.) related to a sale when a purchaser makes a settlement of the prices for the goods are collectively performed. Nowadays, the POS server is widely used in large distribution stores (department, mart, etc.).

As shown in the figure, the transaction approval terminal 70 generates the credit card authentication request data by means of the contactless radio-frequency identification (ST203) of the mobile terminal 60, and combines the generated authentication request data and the settlement data to prepare the price settlement request data which in turn, are transmitted to the POS server 75 (ST213).

The POS server 75 which has received the price settlement request data transmits the credit card authentication request data (peculiar code, encryption key, rolling code, response code) in the price settlement request data to the authentication system 20 (ST223).

The authentication system 20 recognizes the peculiar code of the transponder included in the received authentication request data, extracts the credit card connection information, such as the credit card number and the term of validity, corresponding to the peculiar code of the recognized transponder, and then transmits the extracted information to the POS server 75 (ST233).

As for subsequent steps ST243, ST253, ST263, ST273, ST283, ST293 according to the credit card settlement approval request at the POS server 75 which has received the credit card connection information such as the credit card number, since they are well known from the prior art and FIG. 2, the detailed descriptions thereof will be omitted.

Thus, the credit card transaction authentication system and method using the mobile terminal according to the present invention can be variously applied to a commercial transaction and form wholesome commercial order.

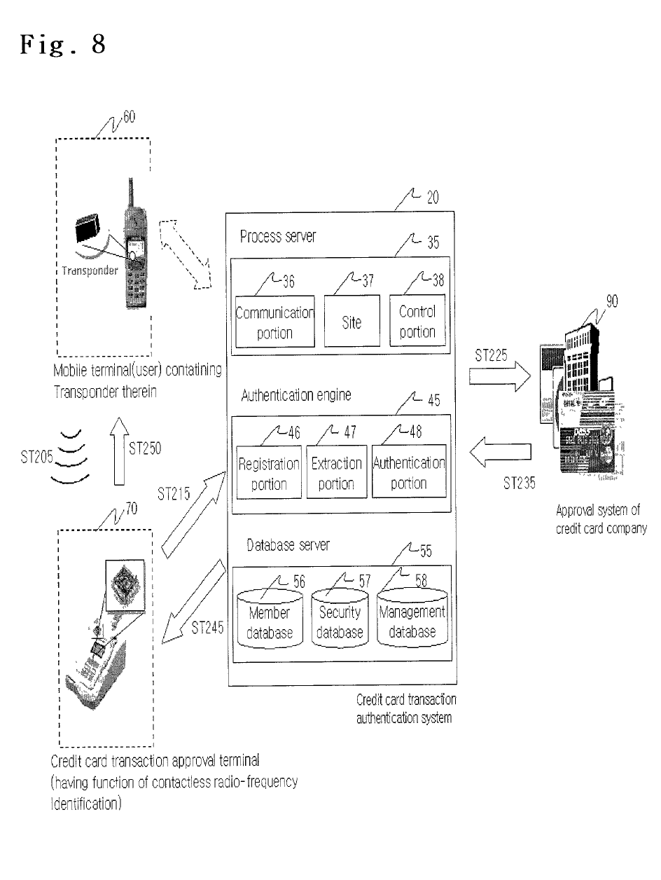

FIG. 8 is a conceptual view schematically showing credit card authentication of a credit card transaction authentication system using the mobile terminal, according to an embodiment of the present invention.

Referring to the figure, the present invention relates to the authentication system 20 which is connected with the transaction approval terminal 70, which requests the credit card transaction approval through the contactless radio-frequency identification of the mobile terminal 60 containing the transponder, and with the approval system of the credit card company 90, which can approve the credit card settlement of the prices.

When a purchase request for goods or services is offered from the transaction approval terminal 70 by means of the contactless radio-frequency identification of the mobile terminal 60 containing the transponder (ST205), the credit card authentication request data, such as the peculiar code of the transponder, and the settlement data, such as the breakdown of the transaction generated from the transaction approval terminal 70, are combined to prepare the price settlement request data which in turn, are transmitted to the authentication system 20 through the network (ST215).

Here, the credit card authentication request data includes the rolling code generated from the transaction approval terminal 70, the peculiar code and the encryption key of the transponder, and the response code generated by the contactless radio-frequency identification.

The authentication system 20 recognizes the peculiar code of the transponder included in the price settlement request data received from the transaction approval terminal 70, and extracts the credit card connection information, such as the credit card number and the term of validity, corresponding to the peculiar code of the recognized transponder.

When the credit card connection information is extracted, the transaction approval data including the credit card number and the like are generated and then transmitted to the approval system of the credit card company 90 in accordance with the credit card connection information (ST225).

When the approval data for the transaction approval request data are returned from the approval system of the credit card company 90 to the authentication system 20, the authentication system 20 transmits the transaction approval data to the transaction approval terminal (ST245).

The transaction approval terminal 70 to which the transaction approval result has been returned informs the user 60 of the price settlement result based on the breakdown of the transaction approval result (ST255).

As for a block constitutional diagram for embodying the authentication system 20, since it is fully illustrated in FIG. 3, the detailed description thereof will be omitted.

In such way, since the user of the credit card is provided with elimination of a risk of information exposure and convenience of the contactless radio-frequency identification, the user can enjoy the new technology in daily life.

In addition, through the connection with the web site or mobile site of the authentication system 20 of the present invention by the user of the mobile terminal, registration, modification and update of the credit card connection information; change of information; and modification and update of the environment configuration such as a locking function and an alarm function can be performed. Thus, various kinds of credit cards can be selectively used if necessary so as to provide an environment in which a credit card settlement can be effectively made.

Furthermore, the credit card transaction authentication method using the mobile terminal of the present invention may further include a member authentication step of, when the user of the mobile terminal connects with the web or mobile site of the authentication system through a network, confirming whether the user is a member; a member's initial-screen displaying step of, when it has been determined from the member authentication step that the user is a member, providing environment configuration for setting whether the credit card settlement by the mobile terminal is used, registration, change, and deletion of a credit card for settlement, and a locking function for a work of credit card authentication; and an update step of changing and updating the environment configuration for setting whether the credit card selected by the user is continuously used, registration, change, and deletion of the credit card for settlement, and the locking function for the work of credit card authentication.

As described above, according to the credit card transaction authentication system and method using the mobile terminal of the present invention, the credit card settlement can be made simply by bringing the mobile terminal to the credit card transaction approval terminal, thereby eliminating a cumbersome procedure in which the credit card should be handed over and taken again by the user upon making the credit card settlement.

Further, the credit card settlement can be made by means of the contactless radio-frequency identification performed between the mobile terminal and the credit card transaction approval terminal, thereby preliminarily preventing damage to the credit card, and the like.

Furthermore, the user can select and set one to be used among a plurality of credit cards possessed by the user and can change the setting if the user intends to use another credit card, thereby releasing the user from inconvenience of carrying a plump purse in which a plurality of credit cards are contained.

In addition, according to the present invention, since the telegram of the price settlement request data transmitted from the transaction approval terminal of the member store does not include the user's information, such as the credit card number, recorded in the credit card, there is an advantage in that the credit card information of the user of the credit card is not exposed.

In such way, since the user can selectively use various kinds of credit cards if necessary, and make the credit card settlement without carrying the credit cards with him/her by using only the mobile terminal which the user always carries with him/her, there are advantages in that utility of the credit cards can be increased and wholesome commercial order can be formed.

Although the present invention has been described in detail with respect to the preferred embodiments of the invention, it should be understood that the present invention may use various changes, modifications and equivalents of the invention. It is apparent that the present invention may be equally applied by properly modifying the embodiments. Therefore, the aforementioned description does not limit the scope of the invention defined by the appended claims.

What is claimed is:

1. A credit card transaction authentication system using a mobile terminal for performing a work of credit card authentication for a relay system of a VAN company connected between an approval system of a credit card company, which can approve a credit card settlement of the prices, and a transaction approval terminal, which requests credit card transaction approval by means of contactless radio-frequency identification of said mobile terminal containing a transponder therein, comprising:
a process server connected with said relay system of said VAN company through a network, for operating a site, which provides an environment capable of performing registration and modification of credit card information for a credit card settlement function by means of said contactless radio-frequency identification of said mobile terminal, and for controlling said credit card transaction authentication system to perform said work of credit card authentication for said relay system of said VAN company;
an authentication engine which in accordance with control of said process server, upon receipt of credit card authentication request data on said mobile terminal from said relay system of said VAN company that has received price settlement request data generated from said transaction approval terminal by means of said contactless radio-frequency identification of said mobile terminal, extracts credit card connection information on said mobile terminal, based on said received authentication request data and transmits authentication data to said relay system of said VAN company; and
a database server for storing information on a user of said mobile terminal, said credit card connection information resulted from said contactless radio-frequency identification of said mobile terminal, and information on a peculiar code of said transponder contained in said mobile terminal, according to said control of said process server.

2. The credit card transaction authentication system using the mobile terminal as claimed in claim 1, wherein said process server includes:
a communication portion which allows said process server to be connected with said relay system of said VAN company through said network, and receives and transmits data on registration, change, and authentication of a credit card so that said credit card settlement can be made by means of said contactless radio-frequency identification of said mobile terminal;
a mobile or web site for providing an environment in which member registration of said user of said mobile terminal, and registration, change and environment configuration of said credit card information for said mobile terminal are provided; and
a control portion for controlling operations of said credit card transaction authentication system and for controlling a series of functions for said relay system of said VAN company to perform said work of credit card authentication so that said credit card settlement can be made by means of said contactless radio-frequency identification of said mobile terminal.

3. The credit card transaction authentication system using the mobile terminal as claimed in claim 1, wherein said authentication engine includes:
a registration portion which receives user's information including personal data on said user of said mobile terminal, through said network, receives said peculiar code and an encryption key of said transponder contained in said mobile terminal, and said credit card connection information including a credit card number and the term of validity of said credit card owned by said user of said mobile terminal, and then registers them at said database server;
an extraction portion which receives said credit card authentication request data on said mobile terminal from said relay system of said VAN company which has received said price settlement request data generated from said transaction approval terminal by means of said contactless radio-frequency identification of said mobile terminal and then extracts said credit card connection information for said mobile terminal based on said received authentication request data; and
an authentication portion which transmits said authentication data including said credit card number to said relay system of said VAN company based on said credit card connection information extracted by said extraction portion.

4. The credit card transaction authentication system using the mobile terminal as claimed in claim 1, wherein said database server includes:
a member database which stores member's information including an ID, a password, and basic personal data received when said user of said mobile terminal requests a subscription to a member, and said credit card connection information including said credit card number and said term of validity of said credit card owned by said user of said mobile terminal;
a security database which stores information on said peculiar code and said encryption key of said transponder contained in said mobile terminal; and
a management database which stores history information on the transmission of said authentication data from said relay system of said VAN company based on said credit card authentication request data, and user's environment configuration information for said credit card authentication request from said mobile terminal.

5. The credit card transaction authentication system using the mobile terminal as claimed in claim 1, wherein a POS server is further provided between said transaction approval terminal and said relay system of said VAN company, and said credit card transaction authentication system performs said work of credit card authentication for said POS server.

6. A credit card transaction authentication system using a mobile terminal, comprising:
a process server connected, through a network, with an approval system of a credit card company, which can approve a credit card settlement of the prices, and with a transaction approval terminal, which requests credit card transaction approval by means of contactless radio-frequency identification of a mobile terminal containing a transponder therein, for performing control to provide a work of credit card authentication in response to said credit card settlement of the prices by said contactless radio-frequency identification carried out between said mobile terminal and said transaction approval terminal,
an authentication engine which in accordance with said control of said process server, upon receipt of price settlement request data generated from said transaction approval terminal by means of said contactless radio-frequency identification of said mobile terminal, extracts credit card connection information set in said mobile terminal, based on said received price settlement request data, transmits transaction approval request data to an approval system of a credit card company corresponding to said extracted credit card connection information, and, upon return of a transaction approval data for said transaction approval request data, transmits transaction approval result data to said transaction approval terminal; and
a database server for storing information on a user of said mobile terminal, member store's information for said transaction approval terminal, said credit card connection information resulted from said contactless radio-frequency identification of said mobile terminal, information on a peculiar code of said transponder contained in said mobile terminal, and the like, according to said control of said process server.

7. The credit card transaction authentication system using the mobile terminal as claimed in claim 6, wherein said process server includes:
a communication portion which allows said credit card transaction authentication system to be connected with said transaction approval terminal and said approval system of said credit card company through said network, and receives and transmits data on registration, change, authentication, approval request of a credit card so that said credit card settlement can be made by means of said contactless radio-frequency identification of said mobile terminal;
a mobile or web site for providing an environment in which member registration of said user of said mobile terminal, and registration, change and environment configuration of credit card information for said mobile terminal are provided; and
a control portion for controlling operations of said credit card transaction authentication system and for controlling said work of credit card authentication and a series of functions for obtaining said transaction approval so that said credit card settlement can be made by means of said contactless radio-frequency identification of said mobile terminal.

8. The credit card transaction authentication system using the mobile terminal as claimed in claim 6, wherein said authentication engine includes:
a registration portion which receives user's information including personal data on said user of said mobile terminal, through said network, also receives said peculiar code and an encryption key of said transponder contained in said mobile terminal, and said credit card connection information including a credit card number and the term of validity of said credit card owned by said user of said mobile terminal, and then registers them at said database server;
an extraction portion which receives said price settlement data generated from said transaction approval terminal by means of said contactless radio-frequency identification of said mobile terminal and then extracts said credit card connection information for said mobile terminal based on said received price settlement data; and
an authentication portion which transmits said transaction approval request data to said approval system of said pertinent credit card company based on said credit card connection information extracted by said extraction portion, and, upon return of said transaction approval data for said transaction approval request data, transmits said transaction approval result data to said transaction approval terminal.

9. The credit card transaction authentication system using the mobile terminal as claimed in claim 6, wherein said database server includes:
a member database which stores member's information including an ID, a password, and basic personal data received when said user of said mobile terminal requests a subscription to a member, said credit card connection information including said credit card number and said term of validity of said credit card owned by said user of said mobile terminal, and member store's information for said transaction approval terminal;
a security database which stores information on said peculiar code, said encryption key of said transponder contained in said mobile terminal, and a peculiar code of said transaction approval terminal; and
a management database which stores history information on said credit card authentication or said transaction approval data related to said price settlement request data from said transaction approval terminal, and user's environment configuration information on said credit card authentication for said mobile terminal.

10. A credit card transaction authentication method using a mobile terminal, performed by a credit card transaction authentication system toward a relay system of a VAN company connected between a transaction approval terminal, which requests a credit card settlement for the prices by means of contactless radio-frequency identification of said mobile terminal containing a transponder therein, and a credit card company, which can approve said credit card settlement of the prices, comprising:
a registration step of receiving and registering credit card connection information including a credit card number and the term of validity of a credit card in correspondence with a peculiar code of said transponder contained in said mobile terminal;
a receipt step of receiving credit card authentication request data including said peculiar code of said transponder contained in said mobile terminal from said relay system of said VAN company which has received data on said credit card settlement for the prices generated by means of said contactless radio-frequency identification performed between said mobile terminal and said transaction approval terminal;
an extraction step of recognizing said peculiar code of said transponder in said received authentication request data, and extracting said credit card connection information such as said credit card number and said term of validity corresponding to said recognized peculiar code of said transponder; and
a transmission step of, upon extraction of said credit card connection information, generating authentication data such as said credit card number and said term of validity corresponding to said credit card connection information, and transmitting said generated authentication data to said relay system of said VAN company.

11. A credit card transaction authentication method using a mobile terminal, performed by a credit card transaction authentication system between a transaction approval terminal, which requests a credit card settlement for the prices by means of contactless radio-frequency identification of said mobile terminal containing a transponder therein, and an approval system of a credit card company, which can approve said credit card settlement of the prices, to make said credit card settlement of the prices by means of said contactless radio-frequency identification between said mobile terminal and said transaction approval terminal, comprising:
a registration step of receiving and registering credit card connection information including a credit card number and the term of validity of a credit card in correspondence with a peculiar code of said transponder contained in said mobile terminal;
a receipt step of receiving price settlement request data including said peculiar code of said transponder contained in said mobile terminal generated from said transaction approval terminal by means of said contactless radio-frequency identification of said mobile terminal;
an extraction step of recognizing said peculiar code of said transponder in said received price settlement request data, and extracting said credit card connection information such as said credit card number and said term of validity corresponding to said recognized peculiar code of said transponder;
a transaction approval request step of, upon extraction of said credit card connection information, generating transaction approval request data including said credit card number, and transmitting said generated transaction approval request data to said approval system of said credit card company corresponding to said credit card connection information; and
a credit card authentication/approval step of, upon return of approval data for said transaction approval request data from said approval system of said credit card company, transmitting transaction approval result data to said transaction approval terminal.

12. The credit card transaction authentication method using the mobile terminal as claimed in claim 10, wherein said transponder contained in said mobile terminal is further provided with an encryption key, said registration step further includes a step of registering said encryption key of said transponder in correspondence with said peculiar code of said transponder contained in said mobile terminal, and said extraction step further includes a step of extracting said encryption key of said transponder corresponding to said recognized peculiar code of said transponder.

13. The credit card transaction authentication method using the mobile terminal as claimed in claim 11, wherein said transponder contained in said mobile terminal is further provided with an encryption key, said registration step further includes a step of registering said encryption key of said transponder in correspondence with said peculiar code of said transponder contained in said mobile terminal, and said extraction step further includes a step of extracting said encryption key of said transponder corresponding to said recognized peculiar code of said transponder.

14. The credit card transaction authentication method using the mobile terminal as claimed in claim 12, wherein said registration step further includes:
a subscription step of receiving basic personal data, information on said mobile terminal containing said transponder, and said credit card connection information such as said credit card number and said term of validity of said credit card of a user inputted when said user of said mobile terminal subscribes to a member;
a confirmation step of confirming, by said approval system of said credit card company, whether said user is a true owner of said credit card and said credit card is available, based on said personal data such as a resident registration number, and said credit card connection information such as said credit card no number; and
a registration step of, when it has been determined by said approval system of said credit card company that said user is the true owner of said credit card and said credit card is available, registering said credit card connection information such as said credit card number and said term of validity of the credit card, and said encryption key of said transponder in correspondence with said peculiar code of said transponder.

15. The credit card transaction authentication method using the mobile terminal as claimed in claim 13, wherein said registration step further includes:
a subscription step of receiving basic personal data, information on said mobile terminal containing said transponder, and said credit card connection information such as said credit card number and said term of validity of said credit card of a user inputted when said user of said mobile terminal subscribes to a member;
a confirmation step of confirming, by said approval system of said credit card company, whether said user is a true owner of said credit card and said credit card is available, based on said personal data such as a resident registration number, and said credit card connection information such as said credit card number; and
a registration step of, when it has been determined by said approval system of said credit card company that said user is the true owner of said credit card and said credit card is available, registering said credit card connection information such as said credit card number and said term of validity of the credit card, and said encryption key of said transponder in correspondence with said peculiar code of said transponder.

16. The credit card transaction authentication method using the mobile terminal as claimed in claim 12, wherein said receipt step further includes:
a transaction step of generating a response code by combining said encryption key of said transponder contained in said mobile terminal and a rolling code produced by said transaction approval terminal;
a credit card price settlement request step of transmitting said price settlement request data, which consists of authentication request data including said peculiar code, said encryption key, said rolling code and said response code and of transaction-related data including the prices for goods and member store code, from said transaction approval terminal to said relay system of said VAN company; and
a step of receiving said authentication request data from said relay system of said VAN company.

17. The credit card transaction authentication method using the mobile terminal as claimed in claim 13, wherein said receipt step further includes:
a transaction step of generating a response code by combining said encryption key of said transponder contained in said mobile terminal and a rolling code produced by said transaction approval terminal; and
a step of receiving said price settlement request data, which consists of authentication request data including said peculiar code, said encryption key, said rolling code, and said response code and of transaction-related data including the prices for goods and member store code, from said transaction approval terminal.

18. The credit card transaction authentication method using the mobile terminal as claimed in claim 12, wherein said extraction step further includes:
a first step of extracting said stored encryption key from said database server by using said received peculiar code and comparing said extracted encryption key with said received encryption key;
a second step of, when said extracted encryption key conforms to said received encryption key, calculating a response code by combining said stored encryption key and said received rolling code; and
a third step of, when said calculated response code conforms to said received response code, extracting said credit card connection information including said credit card number and said term of validity corresponding to said received peculiar code of said transponder.

19. The credit card transaction authentication method using the mobile terminal as claimed in claim 13, wherein said extraction step further includes:
a first step of extracting said stored encryption key from said database server by using said received peculiar code and comparing said extracted encryption key with said received encryption key;
a second step of, when said extracted encryption key conforms to said received encryption key, calculating a response code by combining said stored encryption key and said received rolling code; and
a third step of, when said calculated response code conforms to said received response code, extracting said credit card connection information including said credit card number and said term of validity corresponding to said received peculiar code of said transponder.

20. The credit card transaction authentication method using the mobile terminal as claimed in claim 10, further comprising:
a member authentication step of, when a user of said mobile terminal connects with a web or mobile site of said authentication system through a network, confirming whether said user is a member;
a member's initial-screen displaying step of, when it has been determined from said member authentication step that said user is a member, providing environment configuration for setting whether said credit card settlement by said mobile terminal is used, registration, change and deletion of a credit card for settlement, and a locking function for a work of credit card authentication; and
an update step of changing and updating said environment configuration for setting whether said credit card selected by said user is continuously used, registration, change, and deletion of said credit card for settlement, and said locking function for said work of credit card authentication.

21. The credit card transaction authentication method using the mobile terminal as claimed in claim 11, further comprising:
a member authentication step of, when a user of said mobile terminal connects with a web or mobile site of said authentication system through a network, confirming whether said user is a member;
a member's initial-screen displaying step of, when it has been determined from said member authentication step that said user is a member, providing environment configuration for setting whether said credit card settlement by said mobile terminal is used, registration, change and deletion of a credit card for settlement, and a locking function for a work of credit card authentication; and
an update step of changing and updating said environment configuration for setting whether said credit card selected by said user is continuously used, registration, change, and deletion of said credit card for settlement, and said locking function for said work of credit card authentication.

22. The credit card transaction authentication method using the mobile terminal as claimed in claim 10, wherein a POS server is further provided between said transaction approval terminal and said relay system of said VAN company, and said credit card transaction authentication system performs a work of credit card authentication for said POS server.
